(19) United States
(12) Patent Application Publication
(10) Pub. No.: US 2018/0349157 A1
(43) Pub. Date: Dec. 6, 2018

(54) PROCESSOR-IMPLEMENTED SYSTEMS AND METHODS FOR VEHICLE UPDATING OVER-THE-AIR

(71) Applicant: GM GLOBAL TECHNOLOGY OPERATIONS LLC, Detroit, MI (US)

(72) Inventors: WAHAJ AHMED, BLOOMFIELD HILLS, MI (US); NADAV LAVI, RAMAT-HASHARON (IL); YOHAY BUCHBUT, PARDES-HANNA (IL); BRIAN J. CIESINSKI, COMMERCE TOWNSHIP, MI (US); ALAN D. WIST, MACOMB, MI (US); JESSE P. THOMAS, FENTON, MI (US); LAKSHMI V. THANAYANKIZIL, ROCHESTER HILLS, MI (US)

(73) Assignee: GM GLOBAL TECHNOLOGY OPERATIONS LLC, Detroit, MI (US)

(21) Appl. No.: 15/615,364

(22) Filed: Jun. 6, 2017

(51) Int. Cl. G06F 9/445; G08G 1/00; H04W 48/04

(52) U.S. Cl. CPC G06F 9/44536; H04W 48/04; G08G 1/20; G06F 8/65

(57) ABSTRACT

Systems and methods are provided for enabling an over-the-air update to a plurality of vehicles. A system and method include transmitting a wakeup signal over a communication network to the vehicles that are in a listen state. The update is transmitted over the Wi-Fi network to the vehicles. The transmitting of the update over the Wi-Fi network includes using a transmission scheme to overcome asynchronous communication wakeup of the vehicles.

### TECHNICAL FIELD

The present disclosure generally relates to vehicle communication systems, and more particularly relates to systems and methods for software updating using vehicle communication systems.

### BACKGROUND

Most vehicles manufactured today have multiple computer-controlled systems. Examples include the engine control unit or ECU, anti-lock brakes, air bags and an anti-theft system. The computers or processors that control such systems are referred to interchangeably as either embedded processors or embedded computers. They run software that is provided to the embedded processors when the vehicle is manufactured.

There may be many reasons why the software for an embedded computer might require a modification or improvement over the life of a vehicle. Regardless of the reason, updating the software for an embedded processor typically requires special equipment at an authorized service center or dealer or a complete replacement of an embedded processor and/or the memory devices storing the processor's software. Updating software on many cars can be difficult or costly.

Accordingly, it is desirable to provide systems and methods that facilitate the providing of updates in an efficient and cost effective manner. It is further desirable to provide systems and methods for providing updates to vehicles without or in a minimal manner requiring use of a vehicle's cellular system. Furthermore, other desirable features and characteristics will become apparent from the subsequent detailed description and the appended claims, taken in conjunction with the accompanying drawings and the foregoing technical field and background.

### SUMMARY

Systems and methods are provided to enable an over-the-air update to a plurality of vehicles. A method includes transmitting a wakeup signal over a communication network to the plurality of vehicles that are in a listen state. The vehicles have sensed the wakeup signal at different points in time and are in a state to receive the update. The update is transmitted over a Wi-Fi network to the vehicles. The transmitting of the update over the Wi-Fi network includes using a multi-cast cyclic transmission scheme to overcome asynchronous communication wakeup of the vehicles.

In other embodiments, a method includes the wakeup signal operating to wake the vehicles whose Wi-Fi communication systems use a Wi-Fi sleep-awake cycle.

A method includes that the Wi-Fi sleep-awake cycle includes sleep periods where a vehicle's Wi-Fi is turned off to conserve energy and awake periods where the vehicle's Wi-Fi listen to a Wi-Fi channel for checking for received data packets.

A method includes that the wakeup signal is received by a vehicle with a Wi-Fi chipset that is configurable to operate on low power mode and track traffic over network addresses.

A method includes that when a data packet is received, the Wi-Fi chipset switches to a normal operational mode and wakes up Wi-Fi communications.

A method includes that a backend server transmits to each vehicle multicast streams or data packets related to vehicle type, wherein a completion status update is received that indicates the vehicles which have successfully received the update, wherein the update is sent over the Wi-Fi network using a unicast transmission scheme for the vehicles which have not successfully received the update.

A method includes that the plurality of vehicles is parked in an assembly yard subsequent to vehicle assembly or is parked at a vehicle dealership.

A method includes that the update comprises data for reprogramming a control module of each of the plurality of vehicles or vehicle navigation map updates.

A method includes that the wakeup signal and the generated messages for the update are transmitted to the plurality of vehicles without requiring transmission over a cellular network, wherein the generated messages for the update includes data fields for indicating that a message is directed to a predetermined vehicle type, vehicle trim, and update type.

A method includes that the communication network is the Wi-Fi network or a cellular communication network, wherein the transmitting of the update includes data fields for indicating that a message is directed to a predetermined vehicle type, vehicle trim, and update type.

A system for providing an over-the-air update to a plurality of vehicles comprises a computer storage device for storing the update for transmission over a communication network to the plurality of vehicles and one or more data processors configured to generate a wakeup signal for transmission over the communication network to the plurality of vehicles that are in a listen state. The plurality of vehicles have sensed the wakeup signal at different points in time and are in a state to receive the update. The one or more data processors are configured to generate messages to transmit the update over the Wi-Fi network to the plurality of vehicles using a multi-cast cyclic transmission scheme to overcome asynchronous communication wakeup of the plurality of vehicles.

A system includes that the wakeup signal operates to wake the vehicles whose Wi-Fi communication systems use a Wi-Fi sleep-awake cycle.

A system includes that the Wi-Fi sleep-awake cycle includes sleep periods where a vehicle's Wi-Fi is turned off to conserve energy and awake periods where the vehicle's Wi-Fi listen to a Wi-Fi channel for checking for received data packets.

A system includes that the wakeup signal is received by a vehicle with a Wi-Fi chipset that is configurable to operate on low power mode and track traffic over network addresses.

A system includes that when a data packet is received, the Wi-Fi chipset switches to a normal operational mode and wakes up Wi-Fi communications.

A system includes that a backend server that transmits to each vehicle multicast streams or data packets related to vehicle type, wherein a completion status update is received that indicates the vehicles which have successfully received the update, wherein the update is sent over the Wi-Fi network using a unicast transmission scheme for the vehicles which have not successfully received the update.

A system includes that the plurality of vehicles is parked in an assembly yard subsequent to vehicle assembly or is parked at a vehicle dealership.

A system includes that the communication network is the Wi-Fi network or a cellular communication network and that the update comprises data for reprogramming a control module of each of the plurality of vehicles or vehicle navigation map updates.

A system includes that the wakeup signal and the generated messages for the update are transmitted to the plurality of vehicles without requiring transmission over a cellular network, wherein the generated messages for the update includes data fields for indicating that a message is directed to a predetermined vehicle type, vehicle trim, and update type.

A non-transitory computer readable medium having stored there on instructions for providing an over-the-air update to a plurality of vehicles. The instructions, when executed, cause one or more data processors to: generate a wakeup signal for transmission over a communication network to the plurality of vehicles that are in a listen state. The plurality of vehicles have sensed the wakeup signal at different points in time and are in a state to receive the update. The instructions also generate messages to transmit the update over a Wi-Fi network to the plurality of vehicles using a multi-cast cyclic transmission scheme to overcome asynchronous communication wakeup of the plurality of vehicles.

### DESCRIPTION OF THE DRAWINGS

The exemplary embodiments will hereinafter be described in conjunction with the following drawing figures, wherein like numerals denote like elements, and wherein:

FIG. 1 is a block diagram depicting a system in one embodiment for updating software embedded in a motor vehicle;

FIG. 2 is a block diagram depicting in one embodiment over-the-air (OTA) delivery of updates to vehicles over a Wi-Fi network;

FIG. 3 is a flowchart depicting in one embodiment a software update operational scenario;

FIG. 4 depicts a transmission scheme in one embodiment for handling asynchronous wakeups of vehicles;

FIG. 5 depicts message contents in one embodiment for a cycle data transmission scheme;

FIG. 6 depicts transmission schemes in one embodiment for sending updates to vehicles;

FIG. 7 is a flowchart depicting an operational scenario for providing updates to vehicles; and

FIG. 8 is a flowchart depicting an operational scenario involving vehicle-side operations for handling providing updates to vehicle.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

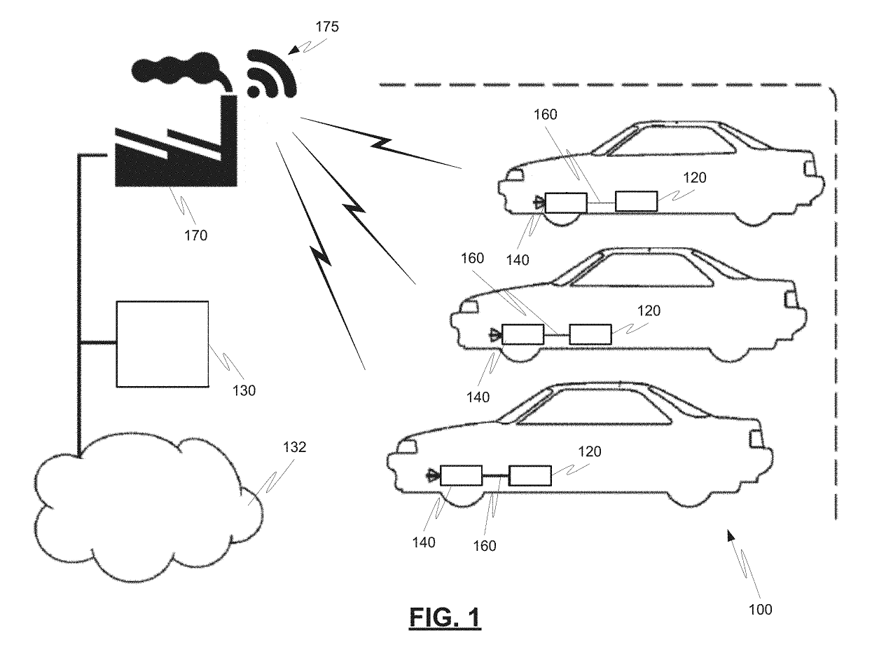

FIG. 1 depicts at 100 a plurality of mobile platforms, e.g., vehicles, operative to communicate wirelessly with a remote system 130, which has been constructed in accordance with an embodiment. Although three vehicles are depicted, it is understood that there can be a multiplicity of vehicles of various build configurations in the general proximity thereof. The vehicles 100 each comprise a motor vehicle, e.g., an automobile, and as depicted are located in an assembly yard adjacent to a vehicle assembly plant 170, prior to being placed into commerce. Each of the vehicles 100 is equipped with a communications transceiver 140 (or multiple transceivers). There is a remote system 130 signally connected to a Wi-Fi network 175. The remote system 130 is operative to communicate wirelessly with each of the vehicles 100 via the transceiver 140 through the Wi-Fi network 175. The vehicles 100 establish communications with the remote system 130 through the Wi-Fi network 175 to transmit electronic data there between.

The vehicles 100 as depicted comprise conventional passenger vehicles for use on public highways, and as shown are parked adjacent to the vehicle assembly plant 170. It should be understood that other types of places where multiple vehicles are co-located can be used with the systems and methods described herein (e.g., dealerships, etc.). Each of the vehicles 100 has a unique identification number, referred to as a VIN, which provides information related to the vehicle manufacturer, vehicle attributes including engine and transmission configurations, model year, manufacturing plant, and a sequential serial number. For passenger vehicles, the VIN is described with reference to ISO standards 3779 and 3780, as known to one of ordinary skill in the art.

Specific elements of the vehicles 100 further include a control module (“CM”) depicted at 120. The control modules 120 can include one or more electronic control devices that have data processors for controlling various operations of the vehicle, and may be configured differently or may contain different operating and control algorithms, depending upon the vehicle configuration that may require software updating with respect to upgrades, bug fixes, etc. Configuration differences include, but are not limited to, differences related to operating schemes for different engine configurations, operating schemes related to manual and automatic transmissions; and operating schemes related to two-wheel drive and four-wheel drive or all-wheel drive systems. Such vehicles may be assembled in a single assembly plant, having variations in the operating and control algorithms. The communications bus 160 facilitates communications of formatted electronic data between various electronic control devices and the transceiver 140. The electronic control devices comprise general or special purpose electronic devices operative to control various aspects of vehicle operation, including, e.g., powertrain control, suspension and brake control, and, climate control (e.g., HVAC systems).

The transceiver 140 includes a wireless communications transceiver that during normal vehicle operation, each transceiver 140 is adapted to receive and authenticate wireless signals as well as transmit information. A memory storage manager communicates the formatted electronic data to the control module 120 at appropriate times.

When the vehicle is shutdown, e.g., parked with ignition key-off, the transceiver 140 is shut down and drawing minimal electrical current. In this state, it has minimal functionality, primarily comprising an ability to respond to a wakeup or activation signal. The transceiver 140 activates for a period of time after the activation signal, and operates to establish a wireless communications link with the remote system 130. The memory storage manager is operably connected to embedded and removable storage devices to provide data storage.

The remote system 130 includes one or more stand-alone computers equipped with and adapted to communicate with vehicles 100. The remote system 130 may be connected to other computer devices via a local area network, e.g., a private network 132, or alternatively, the public Internet. The remote system 130 is signally connected to Wi-Fi network 175 to communicate wirelessly with the vehicles via the transceiver 140 under predetermined conditions, to transmit electronic data there between. The Wi-Fi network 175 comprises a device operative to broadcast a common electronic message that can be received and interpreted by the transceiver 140.

In operation, the remote system 130 is commanded by an operator to communicate with the vehicles 100 in the assembly yard, typically to communicate information for reprogramming one or more of the electronic control devices or provide other types of updates.

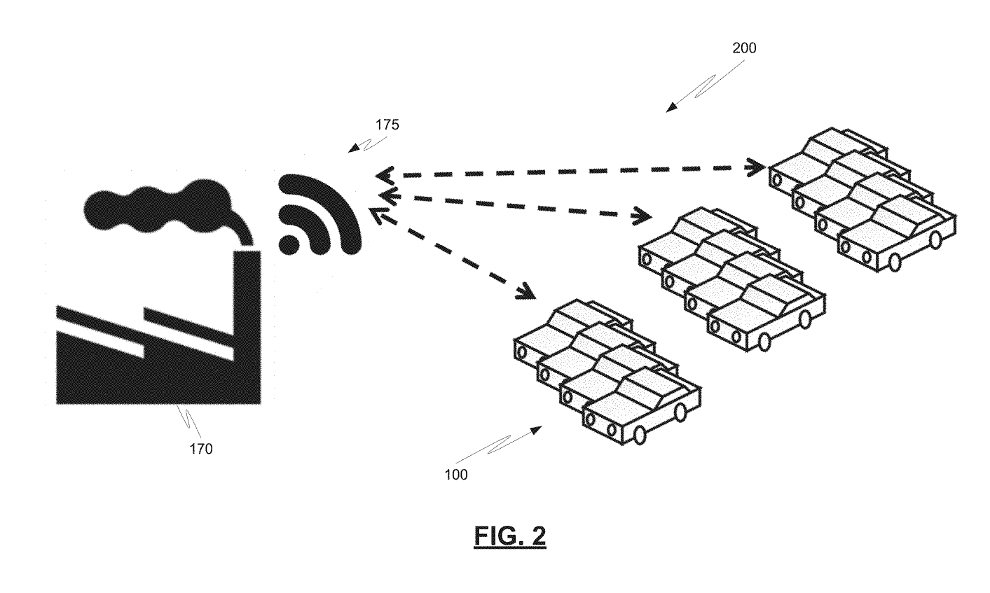

FIG. 2 depicts a system at 200 for delivering over-the-air (OTA) updates to vehicles 100 over the multicast Wi-Fi network 175. The vehicles 100, in this example, are parked at an assembly plant 170 and are configurable for receiving updates. This can include updating information (e.g., potentially large instruction sets) located in a vehicle's software, firmware, control module, database, etc. Examples include updating vehicle navigation maps, infotainment data, vehicle control units, and vehicle components.

To facilitate the updating process, the vehicles 100 are in a listen state for receiving data from the Wi-Fi network 175. A wakeup signal is transmitted to the vehicles 100 over Wi-Fi network 175 which can be a data packet. The vehicles 100 sense the wakeup signal and start to receive the over-the-air data packets which are transmitted over the Wi-Fi network 175. The vehicles 100 sense the wakeup signal and begin to receive the data transmission. The updates are then transmitted in the over-the-air data packets over the Wi-Fi network 175 to the vehicles 100 through a vehicle's transceiver. With such a process in this example, connectivity costs of the over-the-air procedure is reduced because Wi-Fi is used for wakeup and transmission of the updates when the vehicles 100 are parked at a parking lot without requiring cellular connectivity for such operations.

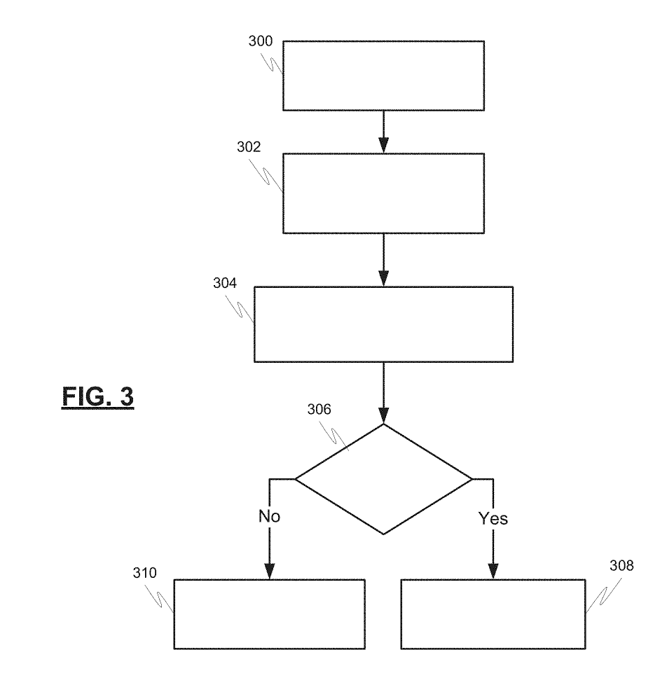

FIG. 3 is a flowchart depicting a software update operational scenario. At process block 300, a software update process begins. At process block 302, a wakeup mechanism is utilized for placing the vehicles in a communication state to receive updates over Wi-Fi. The vehicles are previously provided with network information to recognize which Wi-Fi network to monitor and connect. Network information may include SSID (service set identifier), passkey, and multicast stream information. The information can be provided as part of a control module's configuration or delivered over the cellular (e.g., using OnStar) as part of the wakeup signal. Process block 302 may use different approaches to perform wakeup operations. For example, a wakeup procedure may be based on the vehicle's Wi-Fi sleep-awake cycle. The Wi-Fi sleep-awake cycle involves sleep periods where the Wi-Fi is turned off to conserve energy, and awake periods where it listens to an appropriate Wi-Fi channel to check if a data packet is transmitted.

As another example, a wakeup procedure may be based on a Wi-Fi Network Aware (NaN) approach where a vehicle's Wi-Fi chipset is configured to operate on low power mode and track traffic over a certain IP addresses (e.g., unicast or multicast). When a relevant packet is received, the chipset switches to normal operational mode and wakes up the entire system.

After the wakeup procedure is completed at process block 302, transmission of the software update procedure begins at process block 304. Different transmission schemes can be used so that the software update can be performed for all vehicles despite the vehicles differing in vehicle type and trim (e.g., vehicle designations that identify different levels a vehicle has been equipped). For example, multiple multicast streams may be used for an update that is formatted for each vehicle type and trim.

If all of the vehicles have received the update as determined at decision branch 306, then the update process is complete as indicated at process block 308. However, if a vehicle has not received the update, then the update can be provided at process block 310 using a different transmission scheme such as a unicast transmission scheme. In a unicast transmission situation, the vehicle can indicate the missing packets and the server can deliver them specifically.

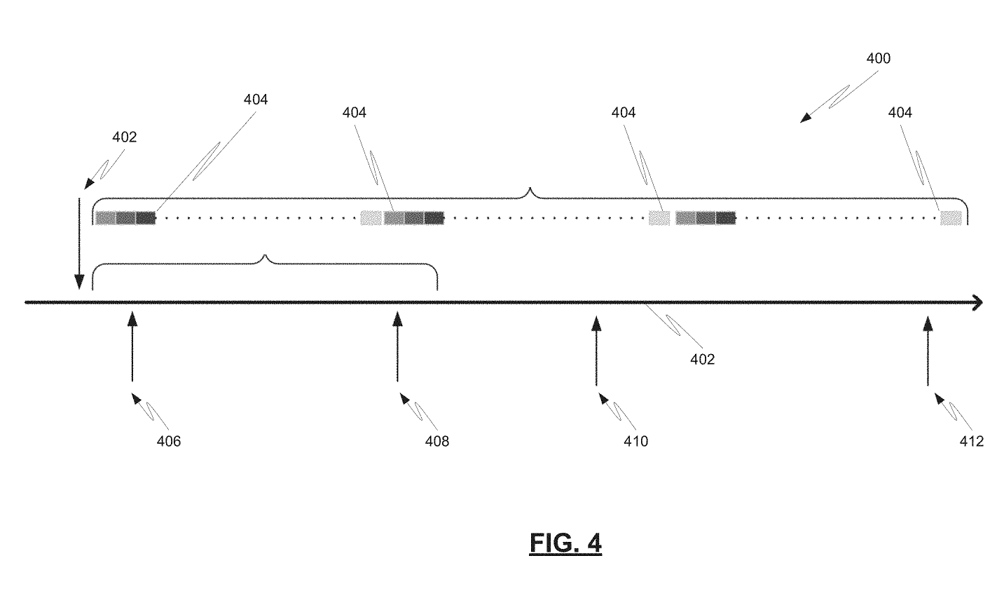

FIG. 4 depicts at 400 a transmission scheme that overcomes asynchronous vehicle wakeup situations. In this example, two vehicles are shown for clarity, but it should be understood that the transmission scheme involves many more vehicles, such as a large number of vehicles parked at assembly plants, dealerships, etc.

Timeline bar 402 indicates that after a software update is triggered at 404, cyclic data transmissions 404 occur. In this example, vehicle 1 wakes up at a different point in time than vehicle 2 as shown respectively at 406 and 408. Vehicle 1 completes its update at 410 based on the cyclic data transmissions 404, and vehicle 2 completes its update 412 based upon such transmissions 404. A single cycle length is based on the number of packets for transmission and the transmission rate (speed). Once a cycle ends, another cycle begins. The number of cycles can be configured/controlled in the server. For example, it can run until all vehicles receive the update.

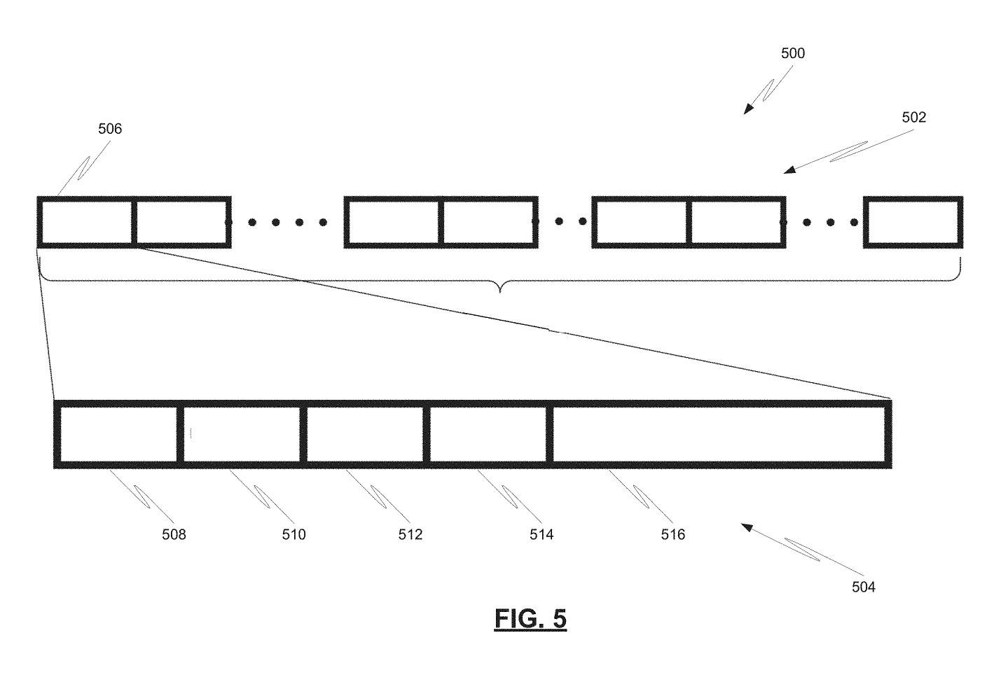

FIG. 5 illustrates at 500 contents of the data transmissions. As shown at 502, each separate transmission includes “N” number of messages. The transmission of these messages ceases after a predetermined number of cycles (“K-cycles”) has occurred. An additional layer of unicast transmissions can be added for vehicles and their messages if all cycles have ended.

An example of a message's content involved in cyclic transmissions is shown at 504 for a first message 506. Data fields 508 and 510 indicate that the message is directed to a particular vehicle type and update type. These fields allow the support of concurrent transmission for multiple vehicle types and update bundles. Data field 512 indicates which message number this particular message is out of the total number of messages it expects to receive as indicated in data field 514. Data field 516 contains the actual data for the message.

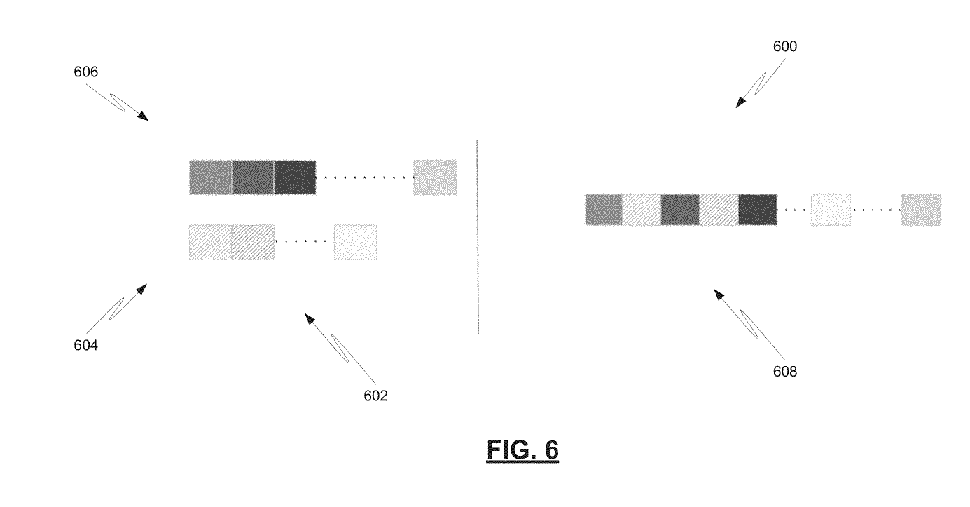

FIG. 6 depicts at 600 transmission schemes that can be sent to the vehicles for software updates. Multi-cast transmission scheme 602 can contain different streams to provide different types of updates. For example, stream 606 is an infotainment stream to be transmitted to the vehicles. Stream 604 is an HVAC update stream that is also transmitted to the vehicles. Multi-cast transmission scheme 602 overcomes the differences between vehicles because the multiple multicast streams are configured to be specific to vehicle type and, if needed, vehicle trim. A single transmission scheme 608 per vehicle type may also be used. In this scheme, a vehicle filters the packets (e.g., stores only relevant packets) according to the packet header.

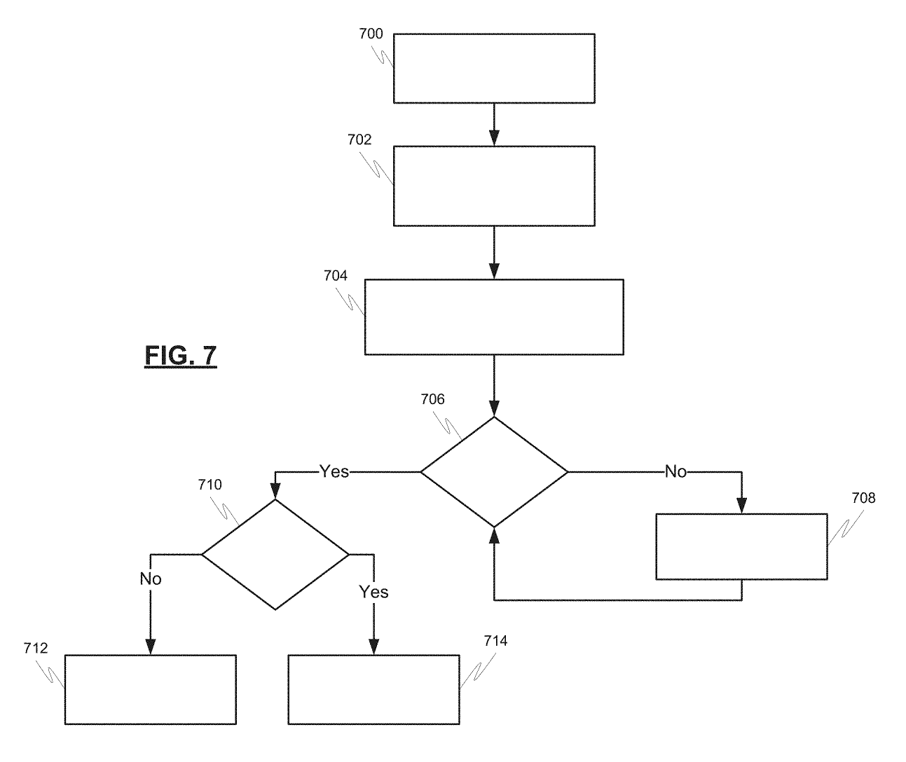

FIG. 7 depicts an operational scenario for providing updates to vehicles. At process block 700, the software update process is triggered. This involves transmitting a wakeup signal over a communication network (e.g., a Wi-Fi network or a cellular communication network) to the vehicles that are in a listen state. At process block 702, the vehicles have sensed the wakeup signal at different points in time (e.g., asynchronous) and are in a state to receive the update.

At process block 704, the update cycle is optimized such that the first priority is a broadcast transmission mechanism, the second priority is a multicast transmission mechanism, and the third priority is a unicast transmission mechanism. Optimization can be performed before the transmission based on the number of vehicles required for an update, the content size, number of updates, etc. For example if only two vehicles need to be updated, the system may select two unicast transmissions. If all the cycles have not completed as determined at decision branch 706, then the transmissions continue at process block 708 until the cycles are completed. When this occurs, a check is performed to see if all the vehicles have received the update as determined at decision branch 710. This check can involve using VINs for vehicle identifiers as part of the process. If the vehicles have properly received the update, then the update cycle is completed as indicated at process block 714. However, if this is not the case, then the update is sent to the relevant vehicles (e.g., as identified with VINs) using a different transmission scheme, such as unicast.

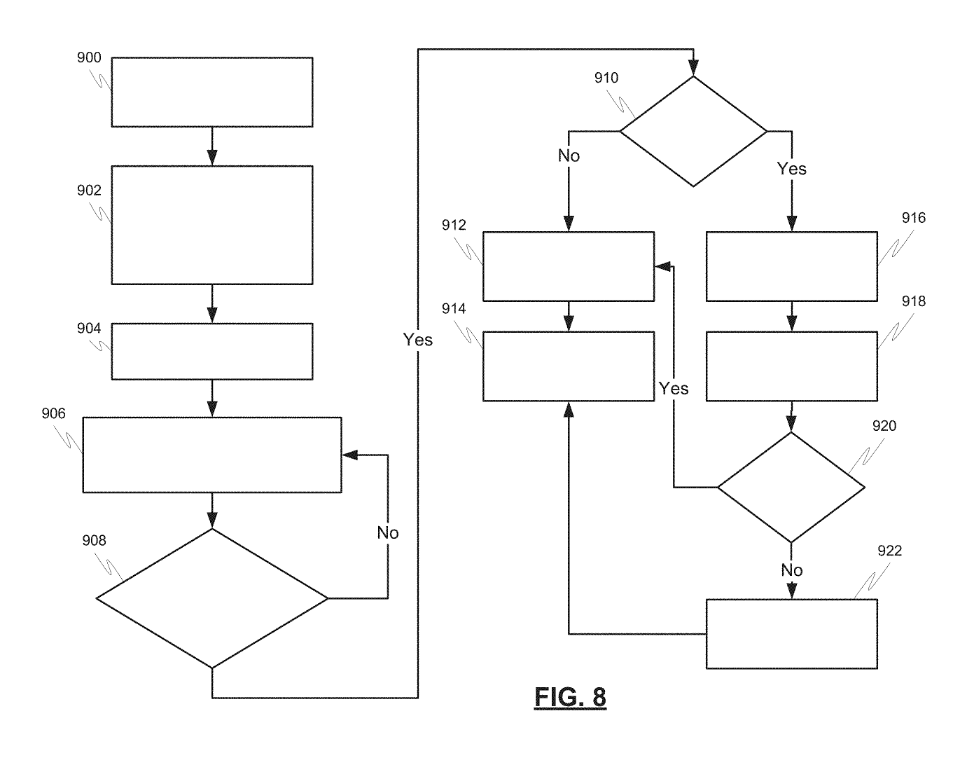

FIG. 8 depicts vehicle operations for handling software updates. At process block 900, a vehicle receives a wakeup trigger. The vehicle's WI-Fi station connects to the appropriate access point (AP) and multicast groups at process block 902. If a single stream transmission is used, then the vehicle receives only this stream. The multicast data can be delivered in the wakeup message. If there are multiples streams, then the wakeup message can include data on which stream relates to which update. Another option is for a vehicle to receive all streams and filter the messages relevant to it. At process block 904, a listen timeout is triggered in order to perform a subsequent check as to whether the timeout has expired.

In process block 906, the vehicle listens to multicast groups and receives data packets. Decision branch 908 checks whether the download has completed. If it has, then processing returns to process block 906. Processing also returns to process block 906 if the listen timeout has not expired so that the vehicle can continue to listen to multicast groups.

After the download is complete, decision branch 910 examines whether the listen timeout has expired. If it has not, then process block 912 communicates over Wi-Fi or a cellular communication network a successful update to the backend server before returning to its sleep sequence at process block 914. When a cellular communication network is used, connectivity can generate charges whereas Wi-Fi is a network free of charges. If the listen timeout has expired as examined at decision branch 910, then the backend server is provided an update regarding the missing packets at process block 916. In process block 918, a different transmission scheme is utilized so that the packet can be received over unicast. After the download is complete as determined at decision branch 920, then processing continues at process block 912 where the update success is communicated to the backend server before the vehicle returns to its sleep sequence at process block 914.

If the download is not complete, however, then processing continues at process block 922 where the failure of the update is communicated to the backend server. At this point, the vehicle returns to a sleep sequence at process block 914.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

As an example of the variations of the systems and methods disclosed herein, the systems and methods can be configured to perform simultaneous OTA software updates for a large number of vehicles parked in the same area, e.g., factory parking lot, without the need to consume expensive cellular data or use expensive and long manual procedures.

What is claimed is:

1. A method for providing an over-the-air update to a plurality of vehicles, comprising:
transmitting a wakeup signal over a communication network to the plurality of vehicles that are in a listen state;
whereby the plurality of vehicles sense the wakeup signal at different points in time and are in a state to receive the update; and
transmitting the update over a Wi-Fi network to the plurality of vehicles;
wherein the transmitting of the update over the Wi-Fi network includes using a multi-cast cyclic transmission scheme to overcome asynchronous communication wakeup of the plurality of vehicles.

2. The method of claim 1, wherein the wakeup signal operates to wake the vehicles whose Wi-Fi communication systems use a Wi-Fi sleep-awake cycle.

3. The method of claim 2, wherein the Wi-Fi sleep-awake cycle includes sleep periods where a vehicle's Wi-Fi is turned off to conserve energy and awake periods where the vehicle's Wi-Fi listen to a Wi-Fi channel for checking for received data packets.

4. The method of claim 1, wherein the wakeup signal is received by a vehicle with a Wi-Fi chipset that is configurable to operate on low power mode and track traffic over network addresses.

5. The method of claim 4, wherein when a data packet is received, the Wi-Fi chipset switches to a normal operational mode and wakes up Wi-Fi communications.

6. The method of claim 1 further comprising:
using a backend server to transmit to each vehicle multicast streams or data packets related to vehicle type;
receiving a completion status update that indicates the vehicles which have successfully received the update;
sending the update over the Wi-Fi network using a unicast transmission scheme for the vehicles which have not successfully received the update.

7. The method of claim 1, wherein the plurality of vehicles is parked in an assembly yard subsequent to vehicle assembly or is parked at a vehicle dealership.

8. The method of claim 1, wherein the update comprises data for reprogramming a control module of each of the plurality of vehicles or vehicle navigation map updates.

9. The method of claim 1, wherein the wakeup signal and the generated messages for the update are transmitted to the plurality of vehicles without requiring transmission over a cellular network, wherein the generated messages for the update includes data fields for indicating that a message is directed to a predetermined vehicle type, vehicle trim, and update type.

10. The method of claim 1, wherein the communication network is the Wi-Fi network or a cellular communication network, wherein the transmitting of the update includes data fields for indicating that a message is directed to a predetermined vehicle type, vehicle trim, and update type.

11. A system for providing an over-the-air update to a plurality of vehicles, comprising:
a computer storage device for storing the update for transmission over a communication network to the plurality of vehicles; and
one or more data processors configured to:
generate a wakeup signal for transmission over the communication network to the plurality of vehicles that are in a listen state;
whereby the plurality of vehicles have sensed the wakeup signal at different points in time and are in a state to receive the update; and
generate messages to transmit the update over the Wi-Fi network to the plurality of vehicles using a multi-cast cyclic transmission scheme to overcome asynchronous communication wakeup of the plurality of vehicles.

12. The system of claim 11, wherein the wakeup signal operates to wake the vehicles whose Wi-Fi communication systems use a Wi-Fi sleep-awake cycle.

13. The system of claim 12, wherein the Wi-Fi sleep-awake cycle includes sleep periods where a vehicle's Wi-Fi is turned off to conserve energy and awake periods where the vehicle's Wi-Fi listen to a Wi-Fi channel for checking for received data packets.

14. The system of claim 11, wherein the wakeup signal is received by a vehicle with a Wi-Fi chipset that is configurable to operate on low power mode and track traffic over network addresses.

15. The system of claim 14, wherein when a data packet is received, the Wi-Fi chipset switches to a normal operational mode and wakes up Wi-Fi communications.

16. The system of claim 11 further comprising a backend server that transmits to each vehicle multicast streams or data packets related to vehicle type;
wherein a completion status update is received that indicates the vehicles which have successfully received the update;
wherein the update is sent over the Wi-Fi network using a unicast transmission scheme for the vehicles which have not successfully received the update.

17. The system of claim 11, wherein the plurality of vehicles is parked in an assembly yard subsequent to vehicle assembly or is parked at a vehicle dealership.

18. The system of claim 11, wherein the communication network is the Wi-Fi network or a cellular communication network, wherein the update comprises data for reprogramming a control module of each of the plurality of vehicles or vehicle navigation map updates.

19. The system of claim 11, wherein the wakeup signal and the generated messages for the update are transmitted to the plurality of vehicles without requiring transmission over a cellular network, wherein the generated messages for the update includes data fields for indicating that a message is directed to a predetermined vehicle type, vehicle trim, and update type.

20. A non-transitory computer readable medium having stored there on instructions for providing an over-the-air update to a plurality of vehicles that, when executed, cause one or more data processors to:
generate a wakeup signal for transmission over a communication network to the plurality of vehicles that are in a listen state;
whereby the plurality of vehicles have sensed the wakeup signal at different points in time and are in a state to receive the update; and
generate messages to transmit the update over a Wi-Fi network to the plurality of vehicles using a multi-cast cyclic transmission scheme to overcome asynchronous communication wakeup of the plurality of vehicles.
